(19) United States
(12) Patent Application Publication
(10) Pub. No.: US 2014/0304012 A1
(43) Pub. Date: Oct. 9, 2014

(54) INSURANCE POLICIES FOR STEM CELLS DEPOSITORS AND METHODS FOR PROVIDING SAME

(71) Applicant: STEM CELL MEDICINE LTD, Ness Ziona (IL)

(72) Inventor: Ehud Marom, Kfar Saba (IL)

(73) Assignee: STEM CELL MEDICINE LTD, Ness Ziona (IL)

(21) Appl. No.: 14/355,969

(22) PCT Filed: Nov. 1, 2012
(86) PCT No.: PCT/IL2012/050432

§ 371 Date: May 2, 2014

Related U.S. Application Data
(60) Provisional application No. 61/554,511, filed on Nov. 2, 2011.

(51) Int. Cl. G06Q 40/08

(52) U.S. Cl. CPC G06Q 40/08
USPC 705/4

(57) ABSTRACT

A method, apparatus and computer program product for generating and applying insurance policies intended to guarantee sufficient amounts of available, viable stem cells to policy holders in case the policy holders are in need of stem cell therapy. An individual may deposit stem cells and give consent to allocate at least some of the stem cells deposited by said individual for public use, and in return be entitled to receive viable stem cells deposited by another individual in case of need.

### FIELD OF THE INVENTION

The present invention relates to insurance policies intended to guarantee sufficient amounts of available, viable stem cells to policy holders in case the policy holders are in need of stem cell therapy. The present invention further relates to methods for providing such insurance policies to individuals who have deposited stem cells, for example, in a stem cell bank.

### BACKGROUND OF THE INVENTION

Stem cells are cells found in all multi-cellular organisms, and are characterized by the ability to renew themselves and differentiate into a diverse range of specialized cell types. Two major categories of stem cells are identified in mammals that may be collected from the body and used for medical applications—embryonic stem cells, which are derived from an embryo at a very early stage of embryonic development, and adult stem cells, which are found in various tissues of the adult body. Stem cells are continuously produced throughout the entire life of an individual (even though a significant decrease in production occurs with age), and it is therefore possible to obtain adult stem cells from a newborn, a child, or an adult. Within the category of adult stem cells, many types of cells are known and they are generally referred to by their tissue origin. For example, hematopoietic stem cells, which are mainly located in the bone marrow and circulation, form the basis for most, if not all, blood cells, and reconstitute the immune system. Additional example is mesenchymal stem cells, that can differentiate, inter alia, into bone, cartilage, fat, tendon and muscle. By introducing stem cells into an area of damage or pathology in the body, the body can be encouraged to repair and renew. Stem cell therapy is therefore a field of growing interest in medicine, with potential utility in the treatment of many types of diseases and/or injuries. The transplanted stem cells may originate from a patient's own body (“autologous transplantation”) or a donor, such as sibling, family member or an unrelated donor (“allogeneic transplantation”).

Stem cells may be collected and stored in repositories, also termed stem cell banks, for future use. The cells are typically cryo-preserved, and may be defrosted and provided to a subject in need thereof upon request. Known stem cell banks can generally be classified into two categories, private banks and public banks. Private banks collect and store stem cells for use by the depositor. Such banks provide donated stem cells back to the donor if needed. Public banks provide typed, anonymous transplant units to the general public based on genetic matching between a donor and a recipient in need. Current banks mainly specialize in collecting cells from the bone marrow and the peripheral blood of adults, and from the umbilical cord blood of healthy new born infants.

There are, however, some limitations associated with preservation of stem cells in banks. One problem is that little is known about the life expectancy of frozen stem cells. Stored stem cells are likely to remain viable for only a limited period of time. At present, it is speculated that stem cells can remain viable for up to 20 years. Thus, there might be cases where samples deposited by a particular donor will not be usable by the time that donor is in need of stem cell therapy. This concern may be particularly relevant for deposits of stem cells from umbilical cord blood, which are deposited at the beginning of life. In addition, the storage and maintenance of the stored cells involve relatively high costs.

WO 2001/032016 relates to the storage of body tissues for large populations, for example storage of autologus tissue. WO 2001/032016 discloses, inter alia, a software for managing a combined tissue deposit and insurance scheme, comprising: a database for associating deposit information with insurance information; and a calculator for determining at least one of a premium and an insurance sum responsive to the deposit information.

US 2003/0014285 discloses a method for use in funding the preservation and storage of biological materials such as adult and neonatal stem cells. In an insurance and/or annuity method, stem cells or other biological material of an individual are stored as a primary or ancillary part of an insurance policy. Fees are collected by an insurance company for the preservation of umbilical cord blood cells including stem cells, peripheral blood cells or other biological material of the policy holder, a secondary insured, or a beneficiary. The preservation and storage company is paid periodically for continuing storage costs either from an insurance policy premium or from the cash value of the insurance policy or directly by the policy holder or other interested party.

US 2004/0258673 discloses an elective healthcare insurance model using an individual's own peripheral blood stem cells for the individual's future healthcare uses. An individual can elect to have his or her own stem cells collected, processed and preserved, while he or she is in healthy or “pre-disease” state, for future distribution for his or her healthcare needs.

US 2006/0190305 discloses a system and method for providing insurance to an individual who has deposited a body tissue or organ in a depository of such organs or tissues, for example, umbilical cord-blood or blood from another source, foreskin or other skin, lymph, fetal stem cells, adult stem cells, lymph or sperm, the system and method involves establishing an insurance policy for an individual who deposited a body tissue or organ in the depository or for a beneficiary of the depositor. The deposit of the tissue or organ for future use by the individual or beneficiary is a central component of the insurance policy. The insurance policy, in exchange for payment of a periodic premium, indemnifies the policy holder or his beneficiary for at least some of the expenses associated with a medical or cosmetic treatment that requires body material of the type previously deposited by the depositor in the depository.

US 2007/0050218 discloses a business method comprising: establishing a Key Person, Term Life, or Critical Illness insurance policy program for selected policy holders or beneficiaries by an insurance company, collecting a premium to maintain said insurance policies for insured, and paying a service company a predetermined fee in support of services performed by said company on behalf of said policy holders regarding obtaining biological material from said insured and preserving said biological material during the term of said policies; and wherein said biological material may be used to extend the life of one or more of the insured during the term of the policy thereby reducing the likelihood of a payout to the policy holder or beneficiary by said insurance company.

US 2009/0076860 discloses a method for providing insurance. A body material of an animal is deposited in a depository of such animal body material. An insurance policy is established stipulating that the depositor of the animal body material is indemnified for expenses incurred for a medical or cosmetic treatment of the animal requiring body material of the type deposited by the depositor. A periodic premium for the insurance is collected. The invention also provides a system for providing the insurance.

US 2011/0054950 discloses a combination of an insurance policy and a savings plan in which a periodic deposit is made. The insurance policy stipulates that a depositor is indemnified for expenses incurred for a medical or cosmetic treatment requiring body material of the type deposited by a depositor in depository. The savings plan specifies that an accrued value of the savings plan may be utilized to defer costs of maintaining the body tissue or body organ in the depository if the depositor ceases to pay a predetermined periodic service payment to the depository. The invention also provides a system for a method for providing the combination of the invention, and a system for carrying out the method of the invention.

Previously suggested policies mainly provide coverage for expenses associated with stem cell storage and maintenance, or expected costs of future stem cell therapy. However, none of the suggested policies is focused on ensuring the availability of sufficient amounts of viable stem cells in case of need of a stem cell therapy. There is a need for methods and insurance policies directed to ensuring the availability of sufficient amounts of viable stem cells should an individual develop a condition that can be treated by implantation of stem cells.

### SUMMARY OF THE INVENTION

The present invention is directed to insurance policies for stem cells depositors intended to protect against the risk that deposited samples will not be usable by the time their depositor is in need of stem cell therapy. Thus, the insurance policies disclosed herein are intended to guarantee sufficient amounts of available, viable stem cells to individuals in case they are in need of stem cell therapy.

The insurance policies of the present invention are based in part on the following principle: an individual who has deposited a sample or samples of stem cells in a stem cell repository, such as a stem cell bank, gives consent that at least some of the stem cells deposited by the individual become available for use by others under certain conditions defined by the policy. In return, the individual is entitled to receive viable stem cells deposited by others under certain defined conditions and for a particular period of time specified in the policy, in case the individual is in need of stem cell therapy and the original deposited cells are no longer usable and/or not sufficient to meet the individual's medical needs. Typically, the conditions upon which the donated stem cells become available for uses other than by their depositor are chosen by the policy holder, a premium based on the chosen conditions is paid by the policy holder, and if the policy holder is in need of stem cell therapy, the policy holder is entitled to receive stem cells deposited by others according to the conditions defined by the policy.

The insurance coverage provided by the policies of the present invention, for example, the amount and types of stem cells a policy holder is entitled to receive, is determined based on the scope of stem cells deposits made by the policy holder and the premium rate.

According to one aspect, the present invention provides a method for providing insurance to stem cell depositors, the method comprising: i) receiving information about a deposition of stem cells by an individual; ii) establishing an insurance policy wherein the individual gives consent to allocate at least some of the stem cells deposited by said individual for public use, and in return is entitled to receive viable stem cells deposited by others in case of need of stem cell therapy.

As used herein, “public use” refers to clinical use by an individual or individuals other than the depositor of a particular sample. Typically, the individual in need also holds an insurance policy according to embodiments of the present invention. Alternatively or additionally, public use may refer to allocation of samples for uses by the stem cell bank, including for example the use of stem cells for research applications.

It is to be understood that the actual use of stem cells deposited by others to meet a certain medical need of a policy holder depends on genetic matching between the policy holder and the stem cell donor. Thus, the insurance policy of the present invention provides access to a large amount of stem cells deposited by others which are available for public use, but the cells must be screened and tested to ensure genetic matching between a donor and recipient in need. There is no guarantee that a genetically matching sample will be identified.

It is also to be understood that the individual (the policy holder) is entitled to receive stem cells deposited by others which are available for public use (their depositors have given an authorization or allocated stem cells for public use).

In some embodiments, the information received about a deposition of stem cells by an individual comprises the type of stem cells deposited by the individual. In some embodiments, the information comprises the amount of deposits made by the individual.

In some embodiments, the method further comprises defining the conditions under which the deposited stem cells become available for public use.

In some embodiments, the insurance policy defines that upon the deposition of a stem cell sample, a portion of that sample is allocated for public use and the rest of the sample is stored for future use by the depositor (for example, future stem cell treatment for the depositor). In some embodiments, 10% or more of the collected stem cells (10% or more of the sample) are allocated for public use, for example, 15% or more, 20% or more, 25% or more. Each possibility represents a separate embodiment of the invention.

In some embodiments, a portion of the sample is immediately allocated for public use, meaning that there is no period of time when that portion is not available for public use. In other embodiments, a portion of the sample is allocated for public use only after a predetermined period of time defined by the policy. In some embodiments, the time period of storage after which at least a portion of the stem cell sample becomes available for public use is about 5 years or more, for example about 10 years or more, about 15 or more, between 15-20 years. Each possibility represents a separate embodiment of the invention.

The collected stem cells may be subjected to expansion procedures prior to their storage. In some embodiments, if the collected cells are subjected to expansion procedures, a larger portion of the sample may be allocated for public use. In some embodiments, the insurance policy further provides coverage for future expansion procedures, which may be performed when the individual is in need of stem cell therapy.

In some embodiments, the method further comprises defining the conditions under which the individual is entitled to receive stem cells deposited by others.

In some embodiments, the insurance policy defines cases when the individual is entitled to receive viable stem cells deposited by others. Such cases may include at least one of the cases selected from non-viability of the stem cells deposited by the individual, insufficient amount of the stem cells deposited by the individual to meet a certain medical need of said individual, and a need for a type or types of stem cells not deposited by the individual.

In some embodiments, the insurance policy defines that the individual is entitled to receive stem cells of types different from the types of cells the individual has deposited.

Thus, in some embodiments, the insurance policy of the present invention ensures the availability of viable and functioning stem cells even after 15-20 years from the deposition. In alternative or additional embodiments, the insurance policy of the present invention ensures the availability of viable and functioning stem cells of types beyond those deposited by the individual.

In some embodiments, the insurance policy defines what types of stem cells may be allocated to the individual. In alternative or additional embodiments, the insurance policy defines when the individual is entitled to receive stem cells deposited by others.

In some embodiments, the insurance coverage, namely, the types of cells, the amount of cells and timing of allocation of cells deposited by others, is determined according to the scope of deposits made by the individual and/or the premium paid by that individual.

In some embodiments, the individual has deposited only one sample of stem cells. In other embodiments, the individual has deposited more than one sample of stem cells. In some embodiments, a plurality of samples has been deposited, of stem cells of different types and/or from different sources.

In some embodiments, the method further comprises calculating and collecting a premium from the individual.

In some embodiments, the premium is calculated based on the requested coverage. In some embodiments, the premium is calculated based on parameters comprising the probability that the individual will be in need of stem cell therapy during the policy period. In some embodiments, the premium is calculated based on at least one parameter selected from the group consisting of the number of stem cell deposits made by the individual, the type of cells deposited by the individual, the amount of stem cells that the individual agrees to allocate for public use, the age of the individual and the health status of the individual. Each possibility represents a separate embodiment of the invention.

In cases where a broad coverage is requested (for example, including the option to receive stem cell types which are different from those deposited by the individual), higher premiums will be collected.

In some embodiments, the insurance policy is purchased for a limited period of time. According to these embodiments, the policy is in force for a predetermined period of time during which the individual (the policy holder) is guaranteed that viable stem cells will be available, that may be used to meet medical needs the individual may encounter according to the conditions defined by the policy.

In some embodiments, the insurance policy may be renewed for additional predetermined period of time. In some embodiments, renewal of the policy is performed in reduced price. The policy may be renewed with or without deposition of new stem cells samples.

In some embodiments, the insurance policy comprises an option to designate one or more beneficiaries. In some embodiments, a beneficiary is entitled to receive stem cells deposited by the policy holder should the beneficiary needs stem cell therapy. In some embodiments, the beneficiary did not deposit stem cells in a stem cell repository. Thus, in some embodiments, the insurance policy comprises a beneficiary designation.

In some embodiments, the method comprises establishing family insurance policies wherein stem cells deposited by each member of a family are available for use by other members of the family which are part of the same insurance program. According to these embodiments, stem cells collected from a group of individuals (typically relatives that belong to one family) form a family collection of cells which are available for use among the group. In some embodiments, at least a portion of each deposited sample is allocated for public use, outside the family.

In some embodiments, a family member who did not deposit stem cells (“non-depositor”) can also join a family insurance program and is entitled to receive viable stem cells from a family collection.

Thus, in some embodiments, a family insurance policy indicates one or more family members that did not deposit stem cells but are entitled to receive viable stem cells from a family collection, deposited by other family members.

Typically, the premium paid for a non-depositor is higher compared to a premium paid by a family member who deposited stem cells and allocated at least some of them for public use.

In some embodiments, the premium paid for a non-depositor is calculated based on the percentage of stem cells that other family members (who deposited stem cells) agree to allocate for public use. For example, lower premiums may be calculated for the non-depositor in cases when one or more of the family members who deposited stem cells allocate a large percentage for public use.

The method of the present invention may also be used to provide a stem cell insurance policy to an individual who did not deposit stem cells, in return for a higher premium. As used herein, a “stem cell insurance policy” refers to an insurance policy intended to guarantee sufficient amounts of viable and available stem cell to a policy holder, should the policy holder is in need of stem cell therapy.

In some embodiments, a method for providing a stem cell insurance is provided, the method comprising: i) receiving information about a request for a stem cell insurance policy by an individual; ii) establishing an insurance policy wherein the individual pays a premium, and in return is entitled to receive viable stem cells deposited in a stem cell bank by other individuals and allocated for public use, in case of need of stem cell therapy.

In some embodiments, the method further comprises defining the conditions under which the individual is entitled to receive stem cells deposited by others. In some embodiments, the insurance policy defines what types of stem cells may be allocated to the individual. In alternative or additional embodiments, the insurance policy defines when the individual is entitled to receive stem cells deposited by others.

In some embodiments, the method further comprises calculating and collecting a premium from the individual.

In some embodiments, the premium is calculated based on the requested coverage. In some embodiments, the premium is calculated based on parameters comprising the probability that the individual will be in need of stem cell therapy during the policy period. Other parameters may include at least one of the age of the individual and the health status of the individual.

In some embodiments, the individual has a family member who deposited stem cells in a stem cell bank, said family member gave consent to allocate at least some of the stem cells deposited by said family member for public use. In some embodiments, the individual who has a family member who gave consent to allocate stem cells for public use is required to pay a lower premium compared to an individual with no family members, who did not deposit any stem cells.

In some embodiments, the method further comprises establishing a database storing information about the policy holders and their deposited samples. In other embodiments, the method further comprises incorporating the information to an existing database of a stem cell repository.

For example, a stem cell bank may include in its records information about the existence of the insurance policy. The database may provide alerts when a certain sample becomes available for public use. The database may also present data about portions of samples that were allocated for public use.

In some embodiments, the insurance policy further provides coverage for future stem cell-based treatments for the policy holder, should the policy holder develop a condition that can be treated by implantation of stem cells, for example, certain types of cancer and cardiac diseases. According to these embodiments, the insurance policy provides coverage for expenses associated with stem cell treatments that an individual may need. Typically, such insurance policy is associated with higher premiums, depending on the scope of the clinical procedures for covered by the policy.

Some embodiments of the disclosure relate to a computer-implemented method performed by a computerized device, comprising: receiving information about a deposition of stem cells by an individual; determining terms and conditions of an insurance policy wherein the individual gives consent to allocate at least some of the stem cells deposited by said individual for public use, and in return is entitled to receive viable stem cells deposited by another individual; and updating a database with the determined policy. Within the method, the information received about a deposition of stem cells by an individual may comprise one or more details selected from the group consisting of the type of stem cells deposited by the individual and the amount of deposits made by the individual. The method may further comprise determining the conditions under which the deposited stem cells become available for public use. Within the method, the insurance policy may define that upon the deposition of a stem cell sample, a portion of the sample is allocated for public use and the rest of the sample is stored for future use by the depositor. Within the method, about 10% or more of the sample may be allocated for public use. Within the method, a portion of the sample may be allocated for public use only after a predetermined period of time. The method may further comprise determining the conditions under which the individual is entitled to receive stem cells deposited by others. Within the method, the insurance policy may define cases when the individual is entitled to receive viable stem cells deposited by others. Within the method, the cases may comprise one or more cases selected from the group consisting of: non-viability of the stem cells deposited by the individual, insufficient amount of the stem cells deposited by the individual to meet a certain medical need of said individual, and a need for a type or types of stem cells not deposited by the individual. Within the method, the insurance policy may define that the individual is entitled to receive stem cells of types different from the types of cells the individual has deposited. The method may further comprise calculating and collecting a premium from the individual. Within the method, the premium may be calculated based on one or more parameters selected from the group consisting: of the probability that the individual will be in need of stem cell therapy during the policy period, the number of stem cell deposits made by the individual, the type of cells deposited by the individual, the amount of stem cells that the individual agrees to allocate for public use, the age of the individual and the health status of the individual. Within the method, the insurance policy may comprise a beneficiary designation. The method may further comprise establishing family insurance policies wherein stem cells deposited by each member of a family are available for use by other members of the family. Within the method, one or more portions of each deposited sample may be allocated for public use, outside the family. Within the method, a family insurance policy may indicate one or more family members that did not deposit stem cells but are entitled to receive stem cells from the family collection. Within the method, a premium paid for said family member who did not deposit stem cells may be calculated based on the percentage of stem cells allocated for public use by the family members who deposited stem cells. The method may further comprise establishing a database storing information about the policy holders and their deposited samples. The method may further comprise incorporating the information to an existing database of a stem cell repository. Within the method, the insurance policy may further provide coverage for expenses associated with stem cell therapy that an individual may need.

An embodiment of the disclosure relates to a computer-implemented method performed by a computerized device, comprising: receiving information about a request for stem cells by an individual; determining whether the individual has previously deposited stem cells; responsive to determining that the individual has previously deposited stem cells, determining whether the individual has viable stem cells, and providing such stem cells if the stem cells are available and match the request; responsive to more cells being required for the individual, determining whether the individual is entitled to receive more stem cells and determining whether matching stem cells are available; and providing the matching stem cells to the individual.

An embodiment of the disclosure relates to an apparatus having a processing unit and a storage device, the apparatus comprising: a policy and risk management component for determining or receiving general conditions and policies for a stem cell insurer, wherein an insured individual gives consent to allocate at least some of the stem cells deposited by the individual for public use, and in return is entitled to receive viable stem cells deposited by another individual; a policy and fee determination component for determining a policy for an individual depositing stem cells; an entitlement and availability management component for determining whether an individual is entitled for stem cells deposited by the individual or by another individual; a user interface component for enabling a user to interact with the system; and a policy database for storing the policy.

An embodiment of the disclosure relates to a computer program product stored on a non-transitory computer readable medium, the computer program product comprising: a first program instruction for receiving information about a deposition of stem cells by an individual; a second program instruction for determining terms and conditions of an insurance policy, wherein the individual gives consent to allocate at least some of the stem cells deposited by said individual for public use, and in return is entitled to receive viable stem cells deposited by another individual; and a third program instruction for updating a database with the determined policy, wherein said first, second and third program instructions are stored on said non-transitory computer readable medium.

Some embodiments of the disclosure relate to a computer-implemented method performed by a computerized device, comprising: receiving information about a request for a stem cell insurance policy by an individual; determining terms and conditions of an insurance policy wherein the individual pays a premium, and in return is entitled to receive viable stem cells deposited in a stem cell bank by another individual; and updating a database with the determined policy.

An embodiment of the disclosure relates to a computer-implemented method performed by a computerized device, comprising: receiving information about a request for stem cells by an individual; determining whether the individual paid a premium and is entitled to receive allogeneic stem cells; responsive to determining that the individual is entitled to receive allogeneic stem cells, determining whether matching stem cells are available; and providing the matching stem cells to the individual.

An embodiment of the disclosure relates to a computer program product stored on a non-transitory computer readable medium, the computer program product comprising: a first program instruction for receiving information about a request for a stem cell insurance policy by an individual; a second program instruction for determining terms and conditions of an insurance policy, wherein the individual pays a premium, and in return is entitled to receive viable stem cells deposited by another individual; and a third program instruction for updating a database with the determined policy, wherein said first, second and third program instructions are stored on said non-transitory computer readable medium.

These and further aspects and features of the present invention will become apparent from the detailed description and claims which follow.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A is a flowchart of steps in a method for enrolling an applicant with stem cell insurance, in accordance with some exemplary embodiments of the disclosed subject matter;

FIG. 1B, showing a flowchart of steps in a method for retrieving stem cells for an individual from stem cells insurance, in accordance with some exemplary embodiments of the disclosed subject matter; and

FIG. 2 is a block diagram of components of an apparatus for providing stem cells insurance, in accordance with some exemplary embodiments of the disclosed subject matter.

### DETAILED DESCRIPTION OF THE INVENTION

The present invention is directed to insurance policies for stem cells depositors intended to protect against the risk that deposited samples will not be usable by the time their depositor is in need of stem cell therapy. The insurance policies disclosed herein are not only directed to the expenses associated with stem cell storage and maintenance, and/or expenses associated with stem cell treatments, but also focused on ensuring sufficient amount of available stem cells for a person in need thereof.

Typically, the holder of an insurance policy according to embodiments of the present invention deposits stem cells for storage in a stem cell depository. The policy holder gives consent that at least some of these stem cells become available for uses other than by the depositor (public use) under certain conditions defined by the policy. In return, the policy holder is entitled to receive stem cells deposited by others under conditions which are also defined by the policy.

The conditions under which the deposited stem cells become available for public use are chosen by the policy holder, a premium based, inter alia, on the chosen conditions is paid by the policy holder, and if the policy holder is in need of stem cell therapy, the policy holder is entitled to receive stem cells deposited by others.

As used herein, the terms “depositor” and “stem cell depositor”, which are used interchangeably, refer to an individual who has deposited stem cells collected from the individuals' body in a stem cell depository.

The terms “stem cell depository”, “stem cell repository” and “stem cell bank” may be used herein interchangeably, and refer to a repository of stem cells wherein upon request, demand and/or need the stored stem cells can be recovered from storage and allocated to a certain individual for a certain clinical purpose. Alternatively or additionally, the stored stem cells can be used for research applications.

As used herein, the term “stem cell therapy” refers to all of the uses known or envisioned in the art for stem cells. These uses include diagnostic, prophylactic and therapeutic techniques.

According to one aspect, the present invention provides a method for providing insurance to stem cell depositors, the method comprising: i) receiving information about a deposition of stem cells by an individual; ii) establishing an insurance policy wherein the individual gives consent to allocate at least some of the stem cells deposited by said individual for public use, and in return is entitled to receive viable stem cells deposited by others in case of need of stem cell therapy.

Typically, information relating to the deposition of stem cells by an individual who is interested in purchasing an insurance policy according to embodiments of the present invention is received and recorded, for example, at a server of an insurance company or insurance intermediary. Such information may include, for example, the type of stem cells deposited by the individual and/or the amount of deposits made by the individual.

In some embodiments, the individual has deposited only one sample of stem cells. In other embodiments, the individual has deposited more than one sample of stem cells. In some embodiments, a plurality of samples has been deposited, of stem cells of different types and/or from different sources. In some embodiments, additional samples are deposited during the insurance period. In such cases, the conditions defined by the insurance policy, as detailed hereinbelow, may be updated accordingly.

Non-limiting examples of stem cell sources include umbilical cord blood, cord matrix, placental blood, bone marrow, fat, peripheral blood, blood buffy coat, amniotic fluid, skin, kidney, liver, muscle, neural tissue, tooth pulp, mucosa (including but not limited to oral, olfactory and gastric), foreskin, cardiac tissue, bone, cartilage, hair roots and mammary glands.

Non-limiting examples of stem cell types include hematopoietic cells, lineage-committed hematopoietic cells, mesenchymal stem cells, stromal cells, fibroblasts, endothelial progenitor cells, neural stem cells, adipose-derived stem cells, stem cells derived from mucosa, placenta-derived stem cells, amniotic stem cells, cord blood derived stem cells, cord matrix derived stem cells, stem cells derived from foreskin, cardiac stem cells and mammary stem cells.

In some embodiments, the individual has deposited differentiated somatic cells (any cell other than a germ cell or a germ cell precursor) that are manipulated to generate induced pluripotent stem cells (IPSCs), as known in the art. As used herein, the term “induced pluripotent stem cell” refers to a pluripotent stem cell, namely a stem cell capable of generating any fetal or adult cell type, artificially derived from a non-pluripotent cell. IPSCs can be created without the use of embryos, however, the cells resemble embryos in that they can, theoretically and under the appropriate conditions, be made to differentiate into any type of cell found in the body. A non-pluripotent cell may be a fully differentiated cell or a cell whose potency to self-renew and differentiate is lower than that of a pluripotent stem cell. Typically, induced pluripotent stem cells are derived from adult somatic cells.

In some embodiments, the method further comprises determining the conditions under which deposited stem cells become available for public use.

In some embodiments, the insurance policy defines when a deposited sample becomes available for public use. In alternative or additional embodiments, the policy defines which portion of a deposited sample becomes available for public use.

In some embodiments, the insurance policy defines that upon the deposition of a stem cell sample, a portion of that sample is allocated for public use and the rest of the sample is stored for future use by the depositor (for example, future stem cell treatment for the depositor). In some embodiments, about 10% or more of the collected stem cells (10% or more of the sample) are allocated for public use, for example, about 15% or more, about 20% or more, about 25% or more. Each possibility represents a separate embodiment of the invention.

As used herein, the term “about”, when referring to a measurable value such as an amount, is meant to encompass variations of +/−10%, more preferably +/−5%, even more preferably +/−1%, and still more preferably +/−0.1% from the specified value, as such variations are appropriate to perform the disclosed methods.

In some embodiments, a portion of the sample is immediately allocated for public use, meaning that there is no period of time when that portion is not available for public use. In other embodiments, a portion of the sample is allocated for public use only after a predetermined period of time defined by the policy. In some embodiments, the time period of storage after which at least a portion of the stem cell sample becomes available for public use is about 5 years or more, for example about 10 years or more, about 15 or more, between about 15-20 years. Each possibility represents a separate embodiment of the invention.

The collected stem cells may be subjected to expansion procedures prior to their storage. In some embodiments, if the collected cells are subjected to expansion procedures prior to their storage, a larger portion of the sample may be allocated for public use. In some embodiments, the insurance policy further provides coverage for future expansion procedures that may be performed only when the individual is in need of stem cell therapy.

In some embodiments, public use refers to clinical use by an individual or individuals other than the depositor of a particular sample. In alternative or additional embodiments, public use refers to allocation of samples for research applications.

The reservoir of stem cells for public use may be utilized to establish cell lines from cells having good viability and other desirable characteristics. In some embodiments, the stem cells for public use may be utilized for the generation of IPSCs. In some embodiments, the optimized cell lines are used for research applications, including but not limited to, drug development and testing.

In some embodiments, the method further comprises defining the conditions under which the individual is entitled to receive stem cells deposited by others.

In some embodiments, the conditions comprise cases where the individual is entitled to receive viable stem cells deposited by others. According to these embodiments, the insurance policy may define that the individual is entitled to receive stem cells deposited by others in case the stem cells deposited by the individual are no longer viable, their amount is insufficient to meet a certain medical need of the individual, and/or there is a need for a type or types of cells not deposited by the individual.

In alternative or additional embodiments, the conditions comprise the types of stem cells that the individual is entitled to receive. According to these embodiments, the insurance policy may provide for the possibility to receive stem cell of types other than those originally deposited by the individual. Thus, an individual purchasing the policy may deposit stem cells of a certain type or origin, and in case future medical needs require stem cells of different type, the individual will be able to receive samples of the required type(s), which were deposited by others and are available for public use.

The types of cells an individual is entitled to receive, the amount of cells an individual is entitled to receive and timing of allocation of cells deposited by others may be collectively referred to as the insurance coverage. In some embodiments, the insurance coverage is determined according to the scope of deposits made by the individual and/or the premium paid by that individual.

In some embodiments, the method further comprises calculating and collecting premiums from the individual.

In some embodiments, the premiums are calculated based on the requested coverage. In some embodiments, the premiums are calculated based on parameters comprising the probability that the individual will be in need of stem cell therapy during the policy period. In some embodiments, the premiums are calculated based on at least one parameter selected from the group consisting of: the number of stem cell deposits made by the individual, the type of cells deposited by the individual, the amount of stem cells that the individual agrees to allocate for public use, the age of the individual and the health status of the individual.

In some exemplary embodiments, if a broad coverage is requested (for example, including the option to receive stem cell types which are different from those deposited by the individual), higher premiums are collected.

In additional exemplary embodiments, if a plurality of deposits is made by the individual or is expected to be made by the individual, lower premiums are collected.

In other embodiments, the policy holder pays further premium to cover future costs that may be associated with stem cell treatment. According to these embodiments, the insurance policy further provides coverage for future stem cell-based treatments for the policy holder, should the policy holder develop a condition that can be treated by implantation of stem cells. According to these embodiments, the insurance policy provides coverage for expenses associated with stem cell treatments that an individual may need. Typically, such insurance policy is associated with higher premiums. Non-limiting examples of suitable applications of stem cells in cell therapy include organ and tissue therapy applications, forming new blood vessels in damaged tissue, cell therapy applications for neuronal disorders, cell therapy applications for bone and/or cartilage injuries, cell therapy applications for liver disorders, cell therapy applications for heart disorders, cell therapy applications to treat diseases or disorders of the pancreas and gene therapy applications.

In some embodiments, a premium is collected at the beginning of the insurance period. In some embodiments, premiums are collected at predetermined time points. The collected premiums may change or remain constant throughout the insurance period.

In some embodiments, the insurance policy is purchased for a limited period of time. For example, the insurance policy may be purchased for about 10 years or more, about 20 years or more, between 20-30 years, more than about 30 years. Each possibility represents a separate embodiment of the invention. According to these embodiments, the policy is in force for a predetermined period of time during which the individual (the policy holder) is guaranteed that viable stem cells deposited by others will be available for screening and testing in order to find genetically matching cells that may be used by the policy holder according to the conditions defined by the policy.

In some embodiments, the insurance policy may be renewed for additional predetermined period(s) of time. In some embodiments, renewal of the policy is performed in reduced price. The policy may be renewed with or without deposition of new stem cells samples.

In some embodiments, the insurance policy comprises an option to designate one or more beneficiaries. In some embodiments, a beneficiary is entitled to receive stem cells deposited by the policy holder should the beneficiary need stem cell therapy. In some embodiments, the beneficiary has not deposited stem cells in a stem cell repository. Thus, in some embodiments, the insurance policy comprises beneficiary designation.

In some embodiments, the method comprises establishing family insurance policies. According to these embodiments, stem cells deposited by each member of a family are available for use by other members of the family which are part of the same insurance program. Stem cells may be collected from a group of individuals (typically relatives that belong to one family) to form a collection of cells which are available for use among the group. In some embodiments, at least some of the deposited stem cells are allocated for public use, outside the family. In some embodiments, the family insurance policy includes an option to provide stem cells to a family member who has not deposited stem cells. Thus, in some embodiments, the family insurance policy indicates one or more family members that have not deposited stem cells but are entitled to receive viable stem cells deposited by other family members.

Information about the different samples and the terms under which it is possible to use them for public use may be recorded and stored in a database. The database may enable a user to view and preferably also search what samples are available at a given time point.

Thus, in some embodiments, the method further comprises establishing a database. The database may store information about the policy holders. The database may store information about their deposited samples. Information stored within the database, or related computerized instructions may assist in allocating stem cell samples to policy holders. For example, if a policy holder is in need of stem cells therapy, the type of policy the individual holds and the type of deposits the individual has made may be checked, and accordingly it may be determined which samples may be allocated to meet the individual's current medical needs.

In some embodiments, the method further comprises incorporating the information into an existing database of a stem cell repository. For example, a stem cell bank may include in its records information about the existence of the insurance policy.

The database may store data about samples available to the user. Alerts may be fired when a certain sample becomes available for public use. The database may also present data about portions of samples that were allocated for public use.

In some exemplary embodiments, non-available samples are marked as such and cannot be allocated for uses other than by the policy holder.

In some embodiments, the method further comprises storing in a computer readable database stored on a computer readable storage media, data indicative of the insurance policy.

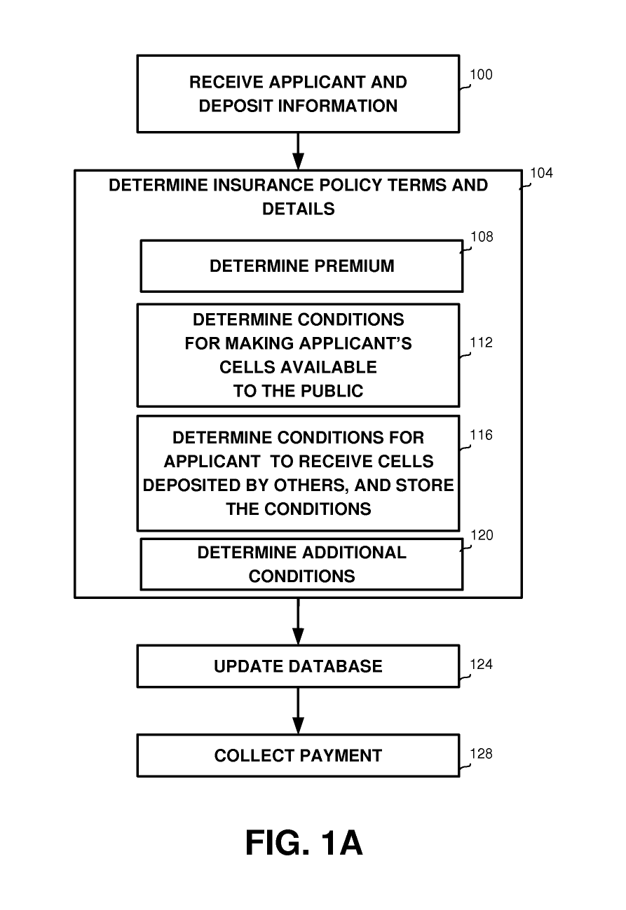

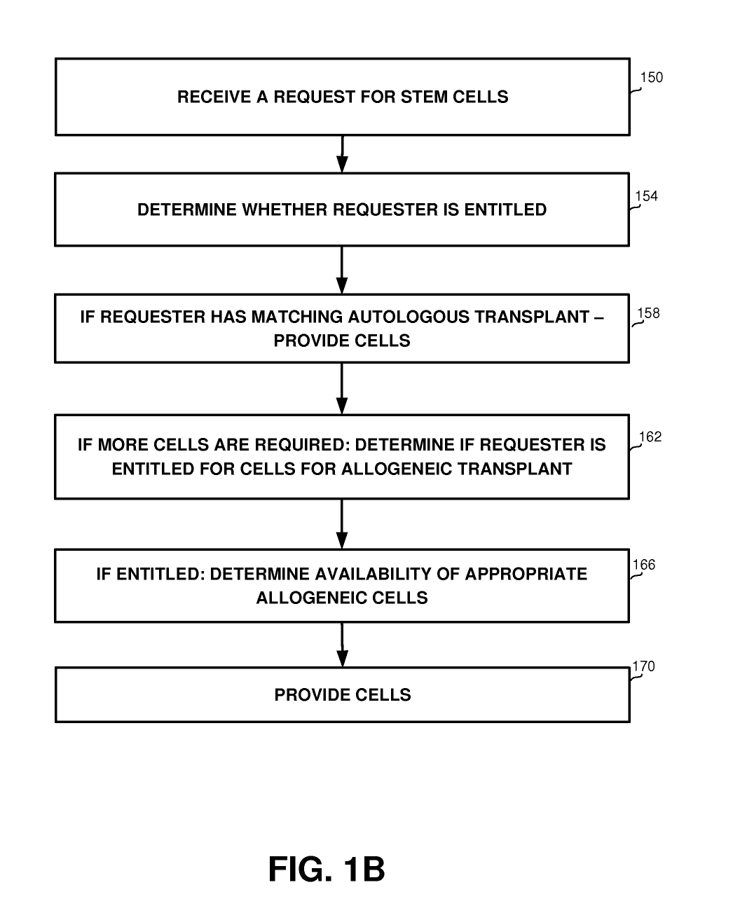

Referring now to FIG. 1A, showing a flowchart of steps in a method for enrolling an applicant with stem cell insurance.

On step 100, information may be received, related to an applicant applying for insurance. The information may comprise personal data of the applicant, demographic data of the applicant, health-related data which may be collected from the applicant's reports, from documents or by conducting medical tests or examinations, or the like. Further information received may relate to the specific stem cells the applicant wishes to deposit: their type, origin, quantity, whether an expansion step of the isolated cells is requested, whether the cells have already been extracted or not, or other parameters. Further information received may relate to the required insurance: its term, the type or types of cells the depositor may want to be entitled to, additional related treatments, or the like. Yet further information may relate to the stem cells the applicant agrees will be provided to other people, such as the quantity or percentage from the samples the applicant intends to deposit, when the cells will be available to others, or the like.

On step 104, the terms and conditions of the insurance may be determined, based on the information received on step 100 and optionally based on existing terms and limitations of the stem cell insurer, for example extreme demand for cells of a particular type, a promotion such as promotion intended to collect cells or cells of particular types, or the like. The insurance policy may define that the individual depositor gives consent to allocate at least some of the stem cells deposited by said individual for public use, and in return may be entitled to receive viable stem cells deposited by others, in case of need of stem cell therapy.

In some exemplary embodiments, determination step 104 may include any of the sub-steps detailed below.

On step 108, the premium required from the applicant may be determined, based upon the insurance the applicant would like to buy, the terms under which the applicant agrees that his or her cells will be given to others, the quantity and type of the deposited cells, or the like. The premium may be a down payment, a recurring payment, a combination thereof, or the like.

On step 112, the conditions under which the applicant's cells will be made available to the public may be determined, and on step 116 the conditions under which the applicant will be entitled to cells deposited by other individuals may be determined, and stored on a storage device.

On step 120 additional conditions may be determined, such as future deposit plan, future extensions of the policy, family or group insurance, or the like.

It will be appreciated that steps 108, 112, 116 and 120 may be performed in any order, may be performed together, may be calculated or determined based on predetermined tables, or the like. It will also be appreciated that one or more insurance schemes may be offered to the applicant to chose from, for example extending the insurance term in return for higher premium or for agreeing to donate a larger part of the cells to the public, etc.

On step 124, optionally after the applicant has agreed to the policy terms, a database of the stem cell insurance may be updated with the information of the applicant, the deposit, the insurance policy and all other relevant details. The database may further be in communication with a stem cell storage and may comprise indication for the exact location and other storage conditions of the stem cells within the storage.

On step 128, payment may be collected from the customer using any desired mechanism.

Referring now to FIG. 1B, showing a flowchart of steps in a method for retrieving stem cells for a customer using stem cells insurance.

On step 150, a request for stem cells may be received. The request may comprise the customer's identifying details, the type and quantity of required stem cells or other required treatment, and additional details such as geographic location, required time frame, or the like.

The request may be preceded by a search step by either the requester or someone on the requester's behalf, or followed by a search by personnel of the insurer. The searcher may search the database for the availability and adequacy of the required samples. The searcher may use a user interface adapted for verifying such availability.

On step 154, it is determined whether the requester is entitled to the stem cells or treatment, for example if the requester has insurance, is a member of family or group insurance, or the like. It may be further determined whether the requester is entitled to the specific request, for example the specific cells or treatment, whether the requester has complied with the commitments in accordance with the policy terms, or other conditions.

On step 158, it may be determined whether the requester may receive the cells he or she previously deposited with the stem cells insurance, for example if the deposited cells match the required type, are the cells still available, whether the cells are expected to be viable, or the like. If the cells are indeed matching, are available in sufficient quantities and expected to be viable, then the cells may be provided to the requester.

In some embodiments it may be determined whether cells deposited by others are more suitable and may be used instead of the cells deposited by the requester, due for example to the number of years the requester's cells have been deposited.

On step 162 it may be determined whether the requester needs and is entitled for additional cells (from an allogeneic source) beyond those deposited by the requester, for example in cases there were no more or not enough cells by the requester, if a different type of cells or another treatment is required, or the like. The entitlement may be determined in accordance with the insurance policy determined and agreed upon when the requester or another individual deposited the cells, or updated at a later time.

On step 166, if such cells or another treatment is indeed required, it may be determined whether appropriate allogeneic cells or treatment are available, e.g., have been deposited by others or may be obtained from another source.

If such cells or treatment are available, then on step 170 they may be provided to the requester.

It will be appreciated that steps 162 and 166 may be performed in reverse order, for example first determining the availability of appropriate allogeneic cells and then checking whether the requester is entitled.

It will be appreciated that in some exemplary embodiments, as disclosed, e.g., in WO 2001/032016, a background check may be performed on the applicant, as with other insurance transactions. Then, a security setup may optionally be agreed upon to assure the privacy of the applicant. A medical examination may be performed, for example to assist in choosing a suitable insurance plan.

The methods and insurance policies of the present invention may be integrated with other health insurance schemes. For example, as disclosed, e.g., in WO 2001/032016, an insurance policy according to embodiments of the present invention may be part of a complete insurance plan, for example as an option in regular health insurance or as a single policy. In an alternative embodiment, the insurance may be considered a risk reduction option, for example allowing a health insurance provider, a disability insurance provider or a life insurance provider to assess a lower risk for people having stem cell sample deposits and thus charge a lower premium.

It will also be appreciated that the applicant may be required to pay for the deposit, or the applicant may receive a refund if the stored samples are not used.

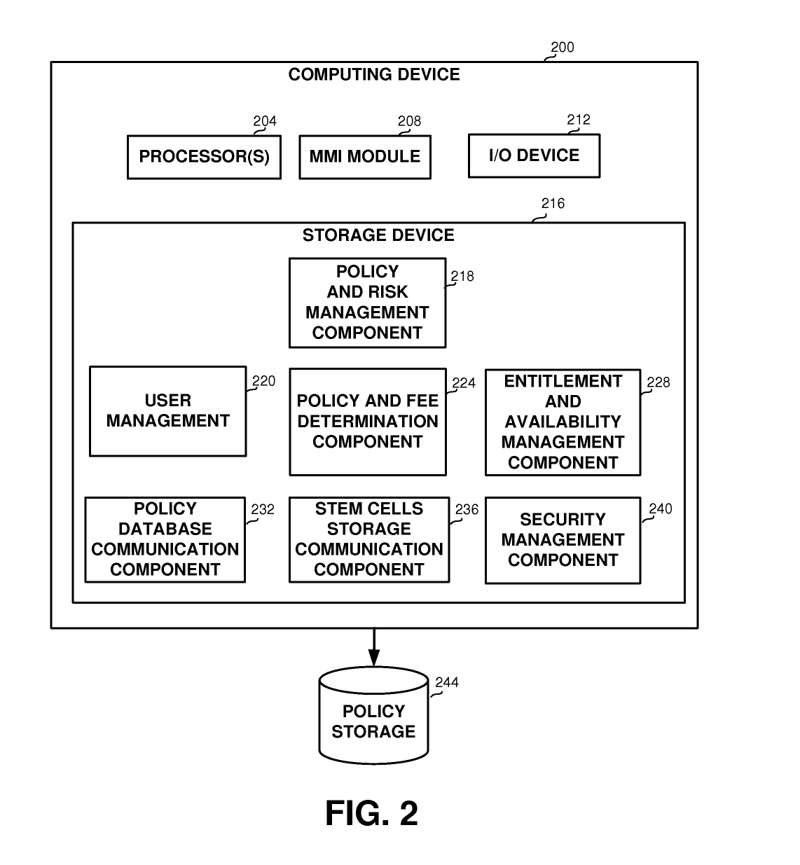

Referring now to FIG. 2, showing a block diagram of components of an apparatus for providing stem cells insurance.

The apparatus comprises a computing device 200, which may comprise one or more processors 204. Any of processors 204 may be a Central Processing Unit (CPU), a microprocessor, an electronic circuit, an Integrated Circuit (IC) or the like. Alternatively, computing device 200 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 204 may be utilized to perform computations required by computing device 200 or any of its subcomponents.

In some exemplary embodiments of the disclosed subject matter, computing platform 200 may comprise MMI module 208. MMI module 208 may be utilized to provide communication between the apparatus and a user for providing input such as entering applicant's details, entering cells request, receiving output or the like.

In some embodiments, computing device 200 may comprise an input-output (I/O) device 212 such as a terminal, a display, a keyboard, a microphone, a loudspeaker, a touch screen, or any other input or output device to interact with the system, to invoke the system and to receive results. It will however be appreciated that the system can operate without human operation and without I/O device 212.

Computing device 200 may comprise one or more storage devices 216 for storing executable components, and which may also contain data during execution of one or more components. Storage device 216 may be persistent or volatile. For example, storage device 216 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 216 may retain program code operative to cause any of processors 204 to perform acts associated with any of the steps shown in FIG. 1 above, for example receiving applicant details, determine insurance policy, determine entitlement for cells or other treatments, or the like.

The apparatus may further comprise a policy database 244, for storing the policies or other conditions of the insured individuals, general terms or policies of the insurer, details about the deposited cells and treatments, or the like. The data may be stored in any required forms, such as files, tables, hierarchies, objects, texts, images, or the like.

Policy database 244 may be implemented on any storage device, as detailed above in association with storage device 216. It will be appreciated that policy database 244 may be stored on storage device 216, or on a different storage device, which may be collocated or remotely located from storage device 244. Policy storage 244 and storage device 216 may communicate using any general or proprietary protocol or communication channel, such as Wide Area Network (WAN), Local Area Network (LAN), the Internet, intranet, or others.

The components detailed below may be implemented as one or more sets of interrelated computer instructions, loaded to storage device 216 and executed for example by any of processors 204 or by another processor. The components may be arranged as one or more executable files, dynamic libraries, static libraries, methods, functions, services, or the like, programmed in any programming language and under any computing environment.

Storage device 216 may comprise a policy and risk management component 218 for determining or receiving general conditions and policies for the insurer, assessing risks associated with different stem cells types, computing premium and deposit fee payments, or the like. Different premiums may be determined for different deposit schemes, and coverage of the insurance policy may be determined based on costs of medical procedures.

Storage device 216 may comprise a user management component 220 for receiving, storing or retrieving user details, such as personal data, demographic data, medical data, insurance policy, payment details, deposits, requests, or the like.

Storage device 216 may also comprise a policy determination component 224 for determining an insurance policy appropriate for an applicant, or some possible policies or conditions for the applicant to select from. Policy determination component 224 may include components or other parts for determining or receiving the premium, deposit payment, part of the user cells that will be made available to others and on which conditions, conditions under which the applicant will be entitled to cells by others or another treatment, or the like. Policy determination component 224 may determine a policy on which the individual depositor gives consent to allocate at least some of the stem cells deposited by said individual for public use, and in return may be entitled to receive viable stem cells deposited by others in case of need of stem cell therapy. Policy determination component 224 may further determine a premium and an insurance sum responsive to the deposit information or applicant's selection.

Yet another component which may be loaded to storage device 216 may be entitlement and availability management component 228, for determining the entitlement or availability of cells or another treatment to an individual in need, as related to cells deposited by the individual, or to cells from another source, depending on the individual's policy, the available cells, or other conditions.

Entitlement and availability management component 228 may comprise a user interface component for enabling a user to interact with the system. For example, the user interface may enable an insured person or someone on his behalf, or an agent of the insurer, to check the availability and adequacy of required samples. The user interface may also be adapted for enabling any other interaction of a user with the system.

In some embodiments, the user interface may not be implemented as part of entitlement and availability management component 228 but may also enable other actions by a user, whether the user is an insured individual or an agent of the insurer.

Storage device 216 may also comprise a policy database communication component 232 for communicating with policy storage 244 for storing or updating policies or policy details, retrieving policies or policy details, adding or removing users, or the like.

In some embodiments, Storage device 216 may further comprise a stem cells storage communication component 236 for communicating with a stem cells storage device, for example managing physical locations of deposits, receiving alerts related to storage conditions, or the like.

Storage device 216 may also comprise a security management component 240, for managing security arrangements, for example for protecting the depositors privacy, the status of the deposits, or the like.

It will be appreciated that the flowchart illustrations and/or block diagrams of methods, apparatus (systems) and computer program products described above are exemplary only and represent some embodiments of the subject matter. It will be understood that blocks of the flowchart illustrations and/or block diagrams, and combinations of blocks in the flowchart illustrations and/or block diagrams, can be implemented as computer program instructions. These computer program instructions may be provided to one or more processors of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block or blocks of block diagrams.

The flowchart illustrations and/or block diagrams may be implemented as software, hardware, firmware or any combination thereof

These computer program instructions may be stored in a non-transitory computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In addition, various signals representing data or events as described herein may be transferred between a source and a destination in the form of electromagnetic waves traveling through signal-conducting media such as metal wires, optical fibers, and/or wireless transmission media (e.g., air and/or space).

In some embodiments, the methods of the present invention may be implemented using software for managing a combined tissue deposit and insurance scheme, for example, as disclosed in WO 2001/032016.

Alternatively, a plurality of separate software programs may be used. In some embodiments, the software comprises customized versions of known software, for example, insurance management software. Various levels of automation may be implemented. In some cases, the software directly performs an activity, for example, calculation of premiums. Alternatively or additionally, the software may control a process. Alternatively or additionally, the software may be used as a reference by a user, for example, providing a premium cost estimate on request for a particular insurance program and patient.

In an exemplary embodiment of the invention, the software monitors payments to offset the cost of storage of the tissue and/or development of tissue manipulation techniques. Optionally, the software calculates premiums and or payoffs based on a treatment package and/or based on a lump sum payment.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1-28. (canceled)

29. A computer-implemented method performed by a computerized device, comprising:
receiving information about a deposition of stem cells by an individual;
determining terms and conditions of an insurance policy wherein the individual gives consent to allocate at least some of the stem cells deposited by said individual for public use, and in return is entitled to receive viable stem cells deposited by another individual; and
updating a database with the determined policy.

30. The method according to claim 29, wherein the information received about a deposition of stem cells by an individual comprises at least one detail selected from the group consisting of the type of stem cells deposited by the individual and the amount of deposits made by the individual.

31. The method according to claim 29, further comprising determining the conditions under which the deposited stem cells become available for public use.

32. The method according to claim 31, wherein the insurance policy defines that upon the deposition of a stem cell sample, a portion of the sample is allocated for public use and the rest of the sample is stored for future use by the depositor.

33. The method according to claim 32, wherein about 10% or more of the sample are allocated for public use.

34. The method according to claim 32, wherein a portion of the sample is allocated for public use only after a predetermined period of time.

35. The method according to claim 29, further comprising determining the conditions under which the individual is entitled to receive stem cells deposited by others.

36. The method according to claim 35, wherein the insurance policy defines cases when the individual is entitled to receive viable stem cells deposited by others.

37. The method according to claim 36, wherein the cases comprise at least one case selected from the group consisting of: non-viability of the stem cells deposited by the individual, insufficient amount of the stem cells deposited by the individual to meet a certain medical need of said individual, and a need for a type or types of stem cells not deposited by the individual.

38. The method according to claim 35, wherein the insurance policy defines that the individual is entitled to receive stem cells of types different from the types of cells the individual has deposited.

39. The method according to claim 29, further comprising calculating and collecting a premium from the individual.

40. The method according to claim 39, wherein the premium is calculated based on at least one parameter selected from the group consisting of: probability that the individual will be in need of stem cell therapy during the policy period, number of stem cell deposits made by the individual, the type of cells deposited by the individual, the amount of stem cells that the individual agrees to allocate for public use, the age of the individual, and the health status of the individual.

41. The method according to claim 29, wherein the insurance policy comprises a beneficiary designation.

42. The method according to claim 29, further comprising establishing family insurance policies wherein stem cells deposited by each member of a family are available for use by other members of the family.

43. The method according to claim 42, wherein at least a portion of each deposited sample is allocated for public use, outside the family.

44. The method according to claim 42, wherein a family insurance policy indicates one or more family members who did not deposit stem cells but are entitled to receive stem cells from the family collection.

45. The method according to claim 44, wherein a premium paid for said family member who did not deposit stem cells is calculated based on the percentage of stem cells allocated for public use by the family members who deposited stem cells.

46. The method according to claim 29, further comprising establishing a database storing information about the policy holders and their deposited samples.

47. The method according to claim 29, further comprising incorporating the information to an existing database of a stem cell repository.

48. The method according to claim 29, wherein the insurance policy further provides coverage for expenses associated with stem cell therapy that an individual may need.

49. The method according to claim 29, further comprising:
receiving information about a request for stem cells by an individual;
determining whether the individual has previously deposited stem cells;
responsive to determining that the individual has previously deposited stem cells, determining whether the individual has viable stem cells, and providing such stem cells if the stem cells are available and match the request;
responsive to more cells being required for the individual, determining whether the individual is entitled to receive more stem cells and determining whether matching stem cells are available; and
providing the matching stem cells to the individual.

50. An apparatus having a processing unit and a storage device, the apparatus comprising:
a policy and risk management component for determining or receiving general conditions and policies for a stem cell insurer, wherein an insured individual gives consent to allocate at least some of the stem cells deposited by the individual for public use, and in return is entitled to receive viable stem cells deposited by another individual;
a policy and fee determination component for determining a policy for an individual deposing stem cells;
an entitlement and availability management component for determining whether an individual is entitled for stem cells deposited by the individual or by another individual;
a user interface component for enabling a user to interact with the system; and
a policy database for storing the policy.

51. A computer program product stored on a non-transitory computer readable medium, the computer program product comprising:
a first program instruction for receiving information about a deposition of stem cells by an individual;
a second program instruction for determining terms and conditions of an insurance policy, wherein the individual gives consent to allocate at least some of the stem cells deposited by said individual for public use, and in return is entitled to receive viable stem cells deposited by another individual; and
a third program instruction for updating a database with the determined policy. wherein said first, second and third program instructions are stored on said non-transitory computer readable medium.
